(19) United States
(12) Patent Application Publication
(10) Pub. No.: US 2019/0014640 A1
(43) Pub. Date: Jan. 10, 2019

(54) Lighting Control System

(71) Applicant: Legrand Electric Limited, Birmingham (GB)

(72) Inventors: Paul Mans, London (GB); Merlin Milner, London (GB)

(73) Assignee: Legrand Electric Limited, Birmingham (GB)

(21) Appl. No.: 16/060,414

(22) PCT Filed: Dec. 8, 2016
(86) PCT No.: PCT/GB2016/053864

§ 371 Date: Jun. 7, 2018

(30) Foreign Application Priority Data
Dec. 8, 2015 (GB) 1521622.9

(51) Int. Cl. H05B 37/02; H05B 39/04; H05B 41/36

(52) U.S. Cl. CPC H05B 37/0218; H05B 37/0227; H05B 41/36; H05B 39/042; H05B 37/0245

(57) ABSTRACT

There is provided a lighting controller for a luminaire (70, 71, 72, 73, 74, 75) in a room (50). The lighting controller comprises at least one switch (104, 106, 108, 110) adjustable to configure the lighting controller to operate in one of a first mode and a second mode. The lighting controller further comprises a receiver configured to receive a light level measurement for the room (10); a processor; and a memory comprising instructions. The instructions, when executed, cause the processor to: if the lighting controller is configured to operate in a first mode, output a first lighting control signal based on the light level measurement modified by a first factor; and if the lighting controller is configured to operate in a second mode, output a second lighting control signal based on the light level measurement modified by a second factor, different from the first factor.

This invention relates to a lighting control system for a building.

### BACKGROUND

A typical room in a non-domestic building will be illuminated by a number of light fittings or luminaires configured in rows parallel to a wall having windows defined therein. Each row is typically positioned at a known distance from the windows. In the past it has been standard to have the light fittings turned on at full brightness throughout the room. In order to conserve energy it is now desirable to dim the luminaires to give a light output that is comfortable for the occupants of the room but uses ambient light received through the window. This is known as daylight linking or daylight harvesting. Typically a light sensor inside the room measures the overall light available and dims the light fittings to a value necessary to achieve an optimal light level. As the ambient light reduces, so the light output from the fittings would be increased, and vice-versa.

Clearly more ambient light is available to those occupants sitting near the window, and the further from the window, the less ambient light is available. So in an optimal scenario, the light fittings dim down more at the rows of luminaires located closer to the window, and less as you progress further into the building. Likewise it is also desirable for the occupant of the room to turn on or off or dim up and down individual rows of light fittings using a manual switch as a user override.

Further, in some applications there is a corridor outside a room. It may be desirable to illuminate the corridor if an occupant is present in any of the rooms adjoining the corridor.

The control of the light fittings to allow this form of daylight linking and corridor control is normally achieved with a lighting control system. The system coordinates the measurement of light level with the dimming of the fittings, and incorporates other controls such as occupancy sensing and user override. The systems are either wired, using network cables or similar; or wireless using a radio protocol. Generally the light fittings are connected to some form of central controller and are controlled by the central controller to dim or to switch on and off.

In known products it is usual to set up a lighting control system using some form of programming utility: either a handset or computer software. In the case of light fittings, the programming identifies the individual fitting or row and allows the luminaire to dim by a certain factor or be overridden by a certain switch.

This invention concerns a method of programming the light fitting without using a separate programming utility.

### BRIEF SUMMARY OF THE DISCLOSURE

In accordance with an aspect of the present disclosure, there is provided a lighting controller for a luminaire in a room. The lighting controller comprises at least one switch adjustable to configure the lighting controller to operate in one of a first mode and a second mode. The lighting controller also comprises a receiver configured to receive a light level measurement for the room, a processor, and a memory comprising instructions. The instructions, when executed, cause the processor to, if the lighting controller is configured to operate in a first mode, output a first lighting control signal based on the light level measurement modified by a first factor. The instructions, when executed, also cause the processor to, if the lighting controller is configured to operate in a second mode, output a second lighting control signal based on the light level measurement modified by a second factor, different from the first factor.

Thus, the lighting controller can use an input from a light level sensor providing a light level measurement differently depending on the mode of operation set in the lighting controller. In particular, a lighting control signal can be different depending on the mode of operation of the lighting controller.

The lighting controller may be for exactly one luminaire. Thus, the lighting controller controls only a single luminaire. Alternatively, the lighting controller may control a plurality of luminaires all connected to a single lighting controller. The lighting control signal may control the luminaire.

The first lighting control signal may be configured to control the luminaire to illuminate to a first level. The second lighting control signal may be configured to control the luminaire to illuminate to a second level dimmer than the first level. Thus, although the light level measurement for the room is based on a sensor at a light level at a single location, the lighting control signal may change based on both the light level measurement and the mode of operation of the lighting controller.

The first mode and the second mode may each be representative of a respective first and second location of the lighting controller within the room. The first mode may be representative of the luminaire being located substantially a first distance from an ambient light source in the room. The second mode may be representative of the luminaire being located substantially a second distance from the ambient light source, the second distance being greater than the first distance. The ambient light source may be a window of the room.

Thus, the lighting controller can ensure that luminaires located further from the ambient light source, for example the window, are configured to illuminate more than luminaires located closer to the ambient light source in order to compensate for the attenuation of the light waves from the ambient light source as they disperse within the room.

The switch may be configured to be adjustable during installation. The switch may be a dual in-line package switch comprising a plurality of switch sliders.

The receiver may be further configured to receive an indication of the presence or absence of a person in the room from an occupancy sensor, whereby to output lighting control signals in dependence on the received indication.

Thus, the lighting controller may be configured not to illuminate the luminaires when the occupancy sensor has not detected the presence of a person in the room for a predetermined time. The lighting controller may be configured to illuminate the luminaires when the occupancy sensor detects the presence of a person in the room.

The receiver may be further configured to receive a switch signal from a light switch for the room. The memory may comprise further instructions which, when executed, cause the processor to, if an off signal is received from the light switch, output a third lighting control signal configured to control the luminaire to switch off. Thus, the lighting controller may be overridden by an input from the light switch.

In accordance with another aspect of the present disclosure, there is provided a luminaire comprising a lighting controller.

In accordance with a further aspect of the present disclosure, there is provided a lighting control system comprising: a luminaire; a light level sensor; and a lighting controller provided with the luminaire. The lighting controller comprises: a receiver in wireless communication with the light level sensor; and at least one switch adjustable to configure the lighting controller to operate in one of a first mode and a second mode. If the lighting controller is configured to operate in a first mode, the lighting controller is configured to control the luminaire to illuminate to a first level based on the light level measurement modified by a first factor. If the lighting controller is configured to operate in a second mode, the lighting controller is configured to control the luminaire to illuminate to a second level based on the light level measurement modified by a second factor, different from the first factor.

The lighting control system may comprise a plurality of luminaires and a plurality of respective lighting controllers. Each lighting controller may be for controlling exactly one respective luminaire.

It will be appreciated that the lighting controller in the lighting control system may be as in any of the compatible embodiments hereinbefore described.

In accordance with yet another aspect of the present disclosure, there is provided a method of controlling a luminaire in a room. The method comprises the steps of: setting a lighting controller to operate in one of a first mode and a second mode; receiving a light level measurement for the room; and if the lighting controller is configured to operate in a first mode, outputting a first lighting control signal based on the light level measurement modified by a first factor; or if the lighting controller is configured to operate in a second mode, outputting a second lighting control signal based on the light level measurement modified by a second factor, different from the first factor.

The step of setting the lighting controller to operate in one of the first mode and the second mode may be performed during an installation of the lighting controller.

Thus, the lighting controller can be set into the first mode or the second mode when the lighting controller is installed in the room. In some cases, it may be necessary to change the mode of the lighting controller where the configuration of the room changes.

The first lighting control signal may be configured to control the luminaire to illuminate to a first level. The second lighting control signal may be configured to control the luminaire to illuminate to a second level dimmer than the first level.

If the luminaire is positioned within a first distance from an ambient light source in the room, the lighting controller may be set to operate in the first mode. If the luminaire is positioned greater than a first distance from the ambient light source, the lighting controller may be set to operate in the second mode.

### BRIEF DESCRIPTION OF THE DRAWINGS

Embodiments of the invention are further described hereinafter with reference to the accompanying drawings, in which:

FIG. 1 is a schematic diagram showing a room layout suitable for use with an embodiment of a lighting control system; and

FIG. 2 is an illustration of a configuration switch panel for use on any of the luminaires of the room shown in FIG. 1.

### DETAILED DESCRIPTION

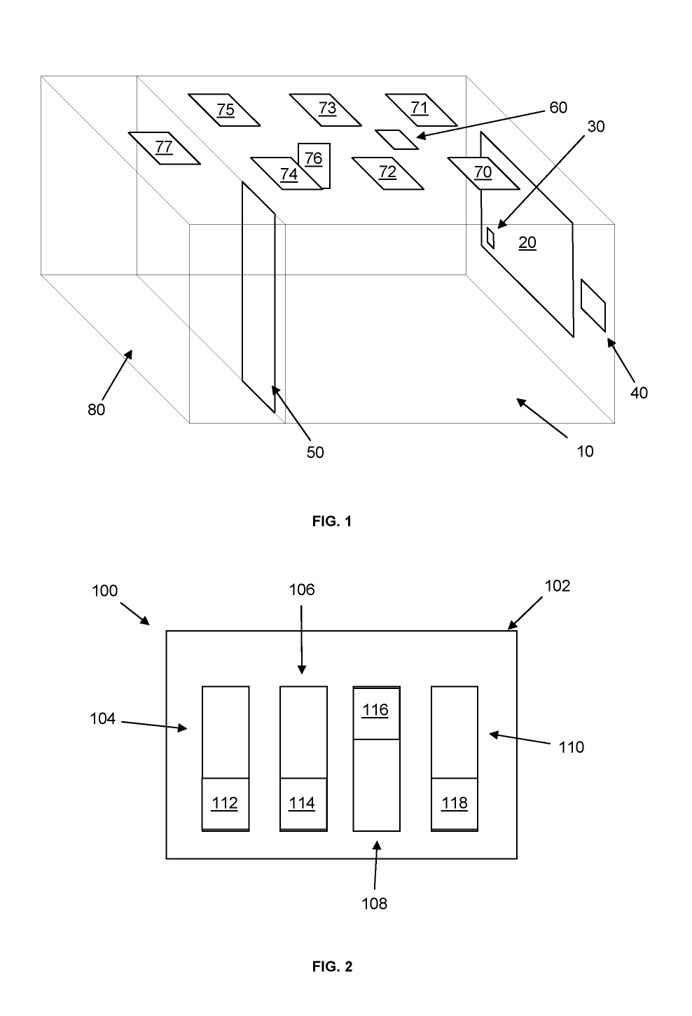

FIG. 1 is a schematic diagram showing a room layout suitable for use with an embodiment of a lighting control system. The room layout shown in FIG. 1 is representative of a typical room layout, wherein a first room 10 comprises a window 20, light sensor 30, occupancy sensor 60, room light switch panel 40 and seven light fittings 70, 71, 72, 73, 74, 75, 76. The first light fitting 70 and second light fitting 71 are arranged on the ceiling in a first row, nearest the window 20. The third light fitting 72 and the fourth light fitting 73 are arranged on the ceiling in a second row, positioned further from the window 20 than the first row. The fifth light fitting 74 and the sixth light fitting 75 are arranged on the ceiling in a third row, positioned yet further from the window 20 than the first and second rows. The ceiling light fittings 70, 71, 72, 73, 74, 75 are all dimmable. The seventh light fitting 76 is a wall fitting and is not dimmable. The first room 10 is linked to a corridor 80 via a doorway 50. The eighth light fitting 77 is positioned on the ceiling of the corridor 80, outside the first room 10.

Receivers mounted within or on top of each of the light fittings 70, 71, 72, 73, 74, 75, 76, 77 will receive information from the light sensor 30, the light switch 40 and the occupancy sensor 60. There is one receiver per light fitting. Note that this differs from a standard lighting control system where the light switch is generally connected to a central lighting controller. Effectively, each light fitting can act as an independent lighting control system for itself.

The occupancy sensor 60 is a sensor capable of detecting the presence of a person within the first room 10, such as a passive infra red sensor. It will be appreciated that other types of occupancy sensors will be known to a person skilled in the art.

It will be appreciated that although the doorway 50 has been shown opposite the window 20, the doorway could instead be defined in other walls of the first room 10.

FIG. 2 is an illustration of a configuration switch panel for use on any of the luminaires of the room shown in FIG. 1. The switch panel 100 is provided on each of the light fittings 70, 71, 72, 73, 74, 75, 76, 77. Typically, the switch panel 100 is incorporated into the receiver unit mounted within or on top of each of the light fittings. The switch panel 100 is capable of selecting one of five settings, corresponding to the five conditions of operation: 1) Row 1; 2) Row 2; 3) Row 3; 4) Do not dim; 5) Corridor. Although five conditions of operation have been defined, in particular three rows of light fittings, it will be appreciated that more or fewer rows of light fittings may be defined. Furthermore, it will also be appreciated that additional conditions of operation may be defined.

In the particular embodiment shown in FIG. 2, the switch panel comprises 4 dual in-line package (DIP) switches 104, 106, 108, 110, each comprising a toggle 112, 114, 116, 118. A first DIP switch 104 corresponding to a selection for Row 1 comprises a first toggle 112 positioned in the down (OFF) position. A second DIP switch 106 corresponding to a selection for Row 2 comprises a second toggle 114 positioned in the down (OFF) position. A third DIP switch 108 corresponding to a selection for Row 3 comprises a third toggle 116 positioned in the up (ON) position. A fourth DIP switch 110 corresponding to a selection for “Do not dim” comprises a fourth toggle 118 positioned in the down (OFF) position. In the situation that all DIP switches 104, 106, 108, 110 have their respective toggles 112, 114, 116, 118 positioned in the down (OFF) position, the switch panel 100 is set in a corridor configuration. Any other switch configurations may be handled in a variety of ways. Although the switch panel 100 has been described using DIP switches, it will be appreciated that other designs may be used to select the appropriate configuration in which the light fitting is to operate.

On installation, a contractor would typically set the switch panel switches to correspond to the location of the fitting. Depending on the switch panel configuration, the operation will vary.

When the light fitting is configured to operate in the row one configuration, the light fitting will be configured to switch on when occupancy is detected by the occupancy sensor 60 and turn off when the room is empty. The operation of the light fitting can be overridden by a first row light switch on room light switch panel 40 allowing the fitting to be turned on or off and dimmed up or down. The light fitting will be configured to dim up or down when changes in ambient light levels are measured by the light sensor 30. The level of dimming due to ambient light will be determined by a pre-programmed “row factor” corresponding to a window location.

When the light fitting is configured to operate in the row two configuration, the light fitting will be configured to switch on when occupancy is detected by the occupancy sensor 60 and turn off when the room is empty. The operation of the light fitting can be overridden by a second row light switch on room light switch panel 40 allowing the fitting to be turned on or off and dimmed up or down. The light fitting will be configured to dim up or down when changes in ambient light levels are measured by the light sensor 30. The level of dimming due to ambient light will be determined by a pre-programmed “row factor” corresponding to a window location. The row factor for the row two configuration is different from the row factor for the row one configuration.

When the light fitting is configured to operate in the row three configuration, the light fitting will be configured to switch on when occupancy is detected by the occupancy sensor 60 and turn off when the room is empty. The operation of the light fitting can be overridden by a third row light switch on room light switch panel 40 allowing the fitting to be turned on or off and dimmed up or down. The light fitting will be configured to dim up or down when changes in ambient light levels are measured by the light sensor 30. The level of dimming due to ambient light will be determined by a pre-programmed “row factor” corresponding to a window location. The row factor for the row three configuration is different from the row factor for the row one configuration and the row two configuration.

When the light fitting is configured to operate in the “do not dim” configuration, the light fitting will switch on and off when occupancy is detected or not by the occupancy sensor 60 and when overridden by operation of a wall light switch on the room light switch panel 40. This fitting does not dim.

When the light fitting is configured to operate in the corridor configuration, the light fitting will switch on and off when occupancy is detected by the occupancy sensor 60 for any of the adjoining rooms.

The room light switch panel 40 also comprises a further light switch 5 configured to operate as a user override for all of the lights regardless of their position, with the exception of the light fitting positioned in the corridor 80.

It will be appreciated that the power for the receiver comes from the power supply for the light fitting, even when the wall light switch has not been operated to explicitly turn on the lamp in the light fitting.

In summary, there is provided a lighting controller for a luminaire (70, 71, 72, 73, 74, 75) in a room (50). The lighting controller comprises at least one switch (104, 106, 108, 110) adjustable to configure the lighting controller to operate in one of a first mode and a second mode. The lighting controller further comprises a receiver configured to receive a light level measurement for the room (10); a processor; and a memory comprising instructions. The instructions, when executed, cause the processor to: if the lighting controller is configured to operate in a first mode, output a first lighting control signal based on the light level measurement modified by a first factor; and if the lighting controller is configured to operate in a second mode, output a second lighting control signal based on the light level measurement modified by a second factor, different from the first factor.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A lighting controller for a luminaire in a room, the lighting controller comprising:
at least one switch adjustable to configure the lighting controller to operate in one of a first mode and a second mode;
a receiver configured to receive a light level measurement for the room;
a processor; and
a memory comprising instructions which, when executed, cause the processor to:
if the lighting controller is configured to operate in a first mode, output a first lighting control signal based on the light level measurement modified by a first factor; and
if the lighting controller is configured to operate in a second mode, output a second lighting control signal based on the light level measurement modified by a second factor, different from the first factor.

2. A lighting controller as claimed in claim 1, wherein the lighting controller is for exactly one luminaire.

3. A lighting controller as claimed in claim 1, wherein the first lighting control signal is configured to control the luminaire to illuminate to a first level and wherein the second lighting control signal is configured to control the luminaire to illuminate to a second level dimmer than the first level.

4. A lighting controller as claimed in claim 3, wherein the first mode and the second mode are each representative of a respective first and second location of the lighting controller within the room.

5. A lighting controller as claimed in claim 4, wherein the first mode is representative of the luminaire being located substantially a first distance from an ambient light source in the room, and the second mode is representative of the luminaire being located substantially a second distance from the ambient light source, the second distance being greater than the first distance.

6. A lighting controller as claimed in claim 1, wherein the switch is configured to be adjustable during installation.

7. A lighting controller as claimed in claim 1, wherein the switch is a dual in-line package switch comprising a plurality of switch sliders.

8. A lighting controller as claimed in claim 1, wherein the receiver is further configured to receive an indication of the presence or absence of a person in the room from an occupancy sensor, whereby to output lighting control signals in dependence on the received indication.

9. A lighting controller as claimed in claim 1, wherein the receiver is further configured to receive a switch signal from a light switch for the room, and wherein the memory comprises further instructions which, when executed, cause the processor to, if an off signal is received from the light switch, output a third lighting control signal configured to control the luminaire to switch off.

10. A luminaire comprising a lighting controller as claimed in claim 1.

11. A lighting control system comprising:
a luminaire;
a light level sensor; and
a lighting controller provided with the luminaire, comprising:
a receiver in wireless communication with the light level sensor; and
at least one switch adjustable to configure the lighting controller to operate in one of a first mode and a second mode,
wherein if the lighting controller is configured to operate in a first mode, the lighting controller is configured to control the luminaire to illuminate to a first level based on the light level measurement modified by a first factor, or
if the lighting controller is configured to operate in a second mode, the lighting controller is configured to control the luminaire to illuminate to a second level based on the light level measurement modified by a second factor, different from the first factor.

12. A lighting control system as claimed in claim 11, wherein the lighting control system comprises a plurality of luminaires and a plurality of respective lighting controllers, and wherein each lighting controller is for controlling exactly one respective luminaire.

13. A lighting control system as claimed in claim 11, wherein the lighting controller is as claimed in claim 1.

14. A method of controlling a luminaire in a room, the method comprising the steps of:
setting a lighting controller to operate in one of a first mode and a second mode;
receiving a light level measurement for the room;
if the lighting controller is configured to operate in a first mode, outputting a first lighting control signal based on the light level measurement modified by a first factor; and
if the lighting controller is configured to operate in a second mode, outputting a second lighting control signal based on the light level measurement modified by a second factor, different from the first factor.

15. A method as claimed in claim 14, wherein the step of setting the lighting controller to operate in one of the first mode and the second mode is performed during an installation of the lighting controller.

16. A method as claimed in claim 14, wherein the first lighting control signal is configured to control the luminaire to illuminate to a first level and wherein the second lighting control signal is configured to control the luminaire to illuminate to a second level dimmer than the first level.

17. A method as claimed in claim 14, wherein, if the luminaire is positioned within a first distance from an ambient light source in the room, the lighting controller is set to operate in the first mode and if the luminaire is positioned greater than a first distance from the ambient light source, the lighting controller is set to operate in the second mode.
